(19) United States
(12) Patent Application Publication
(10) Pub. No.: US 2025/0254629 A1
(43) Pub. Date: Aug. 7, 2025

(54) POWER CONTROL MECHANISM FOR POSITIONING

(71) Applicant: QUALCOMM Incorporated, San Diego, CA (US)

(72) Inventors: Marwen Zorgui, San Diego, CA (US); Alexandros Manolakos, Athens (GR); Srinivas Yerramalli, San Diego, CA (US)

(21) Appl. No.: 18/855,151

(22) PCT Filed: Jun. 1, 2023
(86) PCT No.: PCT/US2023/067785

§ 371 Date: Oct. 8, 2024

(30) Foreign Application Priority Data
Jun. 30, 2022 (GR) 20220100524

(51) Int. Cl. H04W 52/24; H04L 5/00; H04W 64/00; H04W 92/18

(52) U.S. Cl. CPC H04W 52/242; H04L 5/0048; H04W 52/245; H04W 64/00; H04W 92/18

(57) ABSTRACT

This disclosure provides systems, methods, and devices for wireless communication that support power control for positioning. A transmit (Tx) power of a user equipment (UE) for Uu or SL communication may be controlled (e.g., jointly controlled) by the UE or a base station. In a first aspect, the UE determines Tx power based on an SL pathloss value or feedback from another UE. In a second aspect, the UE is configured to adjust Tx power and a resource allocation (e.g., a number of symbols per SL positioning instance). In a third aspect, a base station is configured to receive or determine SL or Uu channel measurements, and signal the SL Tx power for the UE. In a fourth aspect, the base station indicates a scheme to be used by the UE to determine an SL Tx power. Other aspects and features are also claimed and described.

### CROSS-REFERENCE TO RELATED APPLICATIONS

This application claims the benefit of Greek patent application No. 20220100524, entitled, “POWER CONTROL MECHANISM FOR POSITIONING,” filed on Jun. 30, 2022, which is expressly incorporated by reference herein in its entirety.

### TECHNICAL FIELD

Aspects of the present disclosure relate generally to wireless communication systems, and more particularly, to a power control mechanism for positioning, such as sidelink (SL) positioning or joint Uu and SL positioning. Some features may enable and provide improved communications, including determining a user equipment (UE) transmit power, determining position information of the UE, reduced overheard, reduced interference, improved final positioning estimate of the UE, improved received signal qualities, improved UE power management, or a combination thereof.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

With the introduction of 5th Generation (5G) or new radio (NR) networks (sometimes referred to as “5G NR” networks/systems/devices), UEs are able to have higher capability, higher data rate, higher bandwidth. Additionally, UEs are also able to operate in a variety of architectures that provide dual connectivity. Further, 5G provides parameters to improve accuracy of determining positioning of UEs, such as in Uu positioning or sidelink (SL) positioning. As devices continue to improve and “do more”, networks and devices of the network may experience increased network congestion, overhead, and interferences associated with determining positioning information of devices within a network, such as when multiple devices are densely co-located.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication includes receiving, by a network entity from a first user equipment (UE) of multiple UEs associated with a sidelink (SL) positioning session, first pathloss information based on SL communication associated with the multiple UEs. The method also includes transmitting, to the first UE, first transmit power information that indicates a first transmit (Tx) power for Uu communication and the SL.

In an additional aspect of the disclosure, an apparatus includes at least one processor and a memory coupled to the at least one processor. The at least one processor is configured to receive, from a first UE of multiple UEs associated with an SL positioning session, first pathloss information based on SL communication associated with the multiple UEs. The at least one processor is also configured to initiate transmission of, to the first UE, first transmit power information that indicates a first Tx power for Uu communication and the SL.

In an additional aspect of the disclosure, an apparatus includes means for receiving, from a first UE of multiple UEs associated with an SL positioning session, first pathloss information based on SL communication associated with the multiple UEs. The apparatus also includes means for transmitting, to the first UE, first transmit power information that indicates a first Tx power for Uu communication and the SL.

In an additional aspect of the disclosure, a non-transitory computer-readable medium stores instructions that, when executed by a processor, cause the processor to perform operations. The operations include receiving, from a first UE of multiple UEs associated with an SL positioning session, first pathloss information based on SL communication associated with the multiple UEs. The operations also include initiating transmission of, to the first UE, first transmit power information that indicates a first Tx power for Uu communication and the SL.

In an additional aspect of the disclosure, a method for wireless communication includes receiving, by a first UE, a pathloss scheme indicator from a network entity. The pathloss scheme indicator indicates a scheme of multiple pathloss schemes. The method also includes determining, based on the scheme indicated by the pathloss scheme indicator, a first Tx power for an SL positioning session by the first UE.

In an additional aspect of the disclosure, an apparatus includes at least one processor and a memory coupled to the at least one processor. The at least one processor is configured to receive a pathloss scheme indicator from a network entity. The pathloss scheme indicator indicates a scheme of multiple pathloss schemes. The at least one processor is configured to determine, based on the scheme indicated by the pathloss scheme indicator, a first Tx power for an SL positioning session by the first UE.

In an additional aspect of the disclosure, an apparatus includes means for receiving a pathloss scheme indicator from a network entity. The pathloss scheme indicator indicates a scheme of multiple pathloss schemes. The apparatus further includes determining, based on the scheme indicated by the pathloss scheme indicator, a first Tx power for an SL positioning session by the first UE.

In an additional aspect of the disclosure, a non-transitory computer-readable medium stores instructions that, when executed by a processor, cause the processor to perform operations. The operations include receiving a pathloss scheme indicator from a network entity. The pathloss scheme indicator indicates a scheme of multiple pathloss schemes. The operations further include determining, based on the scheme indicated by the pathloss scheme indicator, a first Tx power for an SL positioning session by the first UE.

In an additional aspect of the disclosure, a method for wireless communication includes identifying, by a first UE, a first Tx power based on one or more SL messages between the first UE and one or more UEs. The first Tx power is based on a first pathloss value between the first UE and a second UE of the one or more UEs. The method also includes transmitting an SL sounding reference signal (SRS) position signal based on the first Tx power.

In an additional aspect of the disclosure, an apparatus includes at least one processor and a memory coupled to the at least one processor. The at least one processor is configured to identify, by a first UE, a first Tx power based on one or more SL messages between the first UE and one or more UEs. The first Tx power is based on a first pathloss value between the first UE and a second UE of the one or more UEs. The at least one processor is also configured to initiate transmission of an SL SRS position signal based on the first Tx power.

In an additional aspect of the disclosure, an apparatus includes means for identifying, by a first UE, a first Tx power based on one or more SL messages between the first UE and one or more UEs. The first Tx power is based on a first pathloss value between the first UE and a second UE of the one or more UEs. The apparatus also includes means for transmitting an SL sounding reference signal (SRS) position signal based on the first Tx power.

In an additional aspect of the disclosure, a non-transitory computer-readable medium stores instructions that, when executed by a processor, cause the processor to perform operations. The operations include identifying, by a first UE, a first Tx power based on one or more SL messages between the first UE and one or more UEs. The first Tx power is based on a first pathloss value between the first UE and a second UE of the one or more UEs. The operations further include initiating transmission of an SL SRS position signal based on the first Tx power.

In an additional aspect of the disclosure, a method for wireless communication includes transmitting, by a UE to one or more UEs, a first SRS configuration associated with SL communication between multiple UEs including the UE and the one or more UEs. The first SRS configuration indicating a first Tx power for SL communication and a first number of symbols per SL positioning instance associated with an SL positioning session. The method further including transmitting, to the one or more UEs, or receiving, from the one or more UEs, a first SL SRS position signal based on the first SRS configuration.

In an additional aspect of the disclosure, an apparatus includes at least one processor and a memory coupled to the at least one processor. The at least one processor is configured to initiate transmission of, to one or more UEs, a first SRS configuration associated with SL communication between multiple UEs including the UE and the one or more UEs. The first SRS configuration indicating a first Tx power for SL communication and a first number of symbols per SL positioning instance associated with an SL positioning session. The at least one processor is also configured to initiating transmission of, to the one or more UEs, or receiving, from the one or more UEs, a first SL SRS position signal based on the first SRS configuration

In an additional aspect of the disclosure, an apparatus includes means for transmitting, by a UE to one or more UEs, a first SRS configuration associated with SL communication between multiple UEs including the UE and the one or more UEs. The first SRS configuration indicating a first Tx power for SL communication and a first number of symbols per SL positioning instance associated with an SL positioning session. The apparatus further includes transmitting, to the one or more UEs, or receiving, from the one or more UEs, a first SL SRS position signal based on the first SRS configuration.

In an additional aspect of the disclosure, a non-transitory computer-readable medium stores instructions that, when executed by a processor, cause the processor to perform operations. The operations include initiating transmission of, to one or more UEs, a first SRS configuration associated with SL communication between multiple UEs including the UE and the one or more UEs. The first SRS configuration indicating a first Tx power for SL communication and a first number of symbols per SL positioning instance associated with an SL positioning session. The operations further include initiating transmission of, to the one or more UEs, or receiving, from the one or more UEs, a first SL SRS position signal based on the first SRS configuration.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 shows a diagram illustrating an example disaggregated base station architecture according to one or more aspects.

FIG. 4 is a block diagram illustrating an example wireless communication system that supports power control for positioning according to one or more aspects.

FIG. 5 is a flow diagram illustrating an example process that supports power control for positioning according to one or more aspects.

FIG. 6 is a flow diagram illustrating an example process that supports power control for positioning according to one or more aspects.

FIG. 7 is a flow diagram illustrating an example process that supports power control for positioning according to one or more aspects.

FIG. 8 is a block diagram of an example UE that supports power control for positioning according to one or more aspects.

FIG. 9 is a flow diagram illustrating an example process that supports power control for positioning according to one or more aspects.

FIG. 10 is a block diagram of an example base station that supports power control for positioning according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support power control for positioning. For example, a transmit (Tx) power of a user equipment (UE) for Uu communication, SL communication, may be controlled by the UE or by a base station. For example, the SL communication may include SL positioning. In some implementations, the Tx power of the UE may be jointly controlled for Uu communication and SL communication (e.g., SL positioning). In some implementations, the UE may determine the Tx power based on an SL pathloss value, feedback from another UE that participated in SL communication with the UE in SL communication, or a combination thereof. Additionally, or alternatively, the UE may be configured to adjust the Tx power, a resource allocation (e.g., a number of symbols per SL positioning instance of an SL positioning session), or a combination thereof. For example, in some implementations, the feedback associated with the SL communication may enable the UE to adjust the Tx power, a resource allocation (e.g., a number of symbols per SL positioning instance of an SL positioning session), or a combination thereof. In some implementations, a base station may be configured to receive or determine measurements, such as SL channel measurements, Uu channel measurements, or a combination thereof, and signal or configure the Tx power for one or more UEs. To illustrate, the measurements may include or correspond to a pathloss estimate or a pathloss value, and the base station may determine the Tx power based on the pathloss estimate or the pathloss value. In some implementations, operations described herein may be associated with or correspond to a UE that is in coverage or out of coverage with a base station—e.g., within a coverage area of the base station or out of the coverage area of the base station.

In some implementations, when a UE is out of coverage with a base station, the UE may determine a Tx power for a SL sounding reference signal (SRS) position signal based on one or more SL messages exchanged between the UE and another UE. For example, the one or more SL messages may be exchanged during a discovery phase, a round trip time (RTT) positioning operation, or a double-sided RTT positioning operation. In some implementations, when a UE is out of coverage with a base station, the UE is configured to determine or adjust an SRS configuration that includes or indicates an SL Tx power (e.g., an SL Tx power for SL positioning), a number of symbols (e.g., a number of OFDM symbols per instance of a SL positioning session), or a combination thereof. In some implementations, when a UE is in coverage with a base station, a network entity (e.g., a base station, a core network, a location management function (LMF)) is configured receive measurement information or pathloss information associated with SL communication between multiple UEs. Based on the received measurement information or pathloss information, in addition to uplink (UL) signal measurements or UL pathloss information by the base station, the network entity determines a Tx power for SL communication (e.g., SL positioning) for the multiple UEs. The network entity may transmit Tx power information that includes or indicates the Tx power for the SL communication to the multiple UEs. In some implementations, when a UE is in coverage with a base station, the network entity may indicate a scheme of multiple scheme to a UE to enable the UE to determine a Tx power for SL communication (e.g., SL positioning). The multiple schemes may include an SL pathloss scheme, a UL pathloss scheme, a joint SL and UL pathloss scheme.

Particular implementations of the subject matter described in this disclosure may be implemented to realize one or more of the following potential advantages or benefits. In some aspects, the present disclosure provides techniques for power control for positioning, such as SL positioning. Power control in SL positioning, Uu positioning, or both SL positioning and Uu positioning may allow or enable optimized positioning sessions involving both PC5 and Uu links. Additionally, given that PC5 and Uu links typically have different power requirements, determining and signaling an appropriate power value that optimizes the received signals over both Uu and PC5 link can improve the received signals qualities and thereafter the final positioning estimate. The techniques may also reduce UE power by selecting Tx power for SL communication that is optimized for positioning sessions, based on a current UE power status, or a combination thereof.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHZ-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

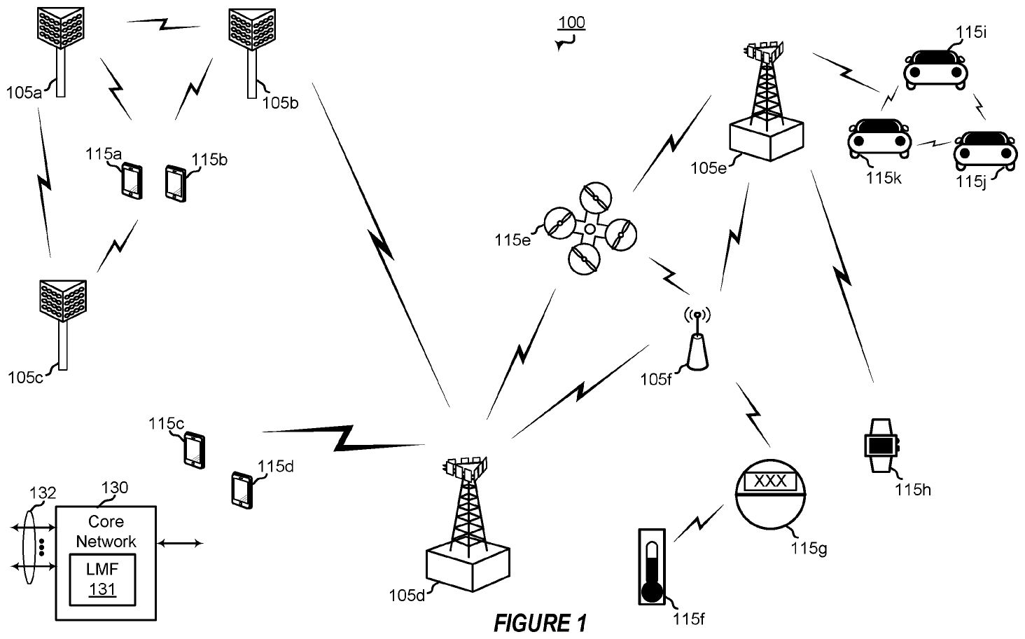

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (COMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

Base stations 105 may communicate with the core network 130 and with one another. For example, base stations 105 may interface with the core network 130 through backhaul links 132 (e.g., via an S1, N2, N3, or other interface). Base stations 105 may communicate with one another over backhaul links (e.g., via an X2, Xn, or other interface) either directly (e.g., directly between base stations 105) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one packet data network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP multimedia subsystem (IMS), or a packet-switched (PS) streaming service.

In some implementations, core network 130 includes or is coupled to a Location Management Function (LMF) 131, which is an entity in the 5G Core Network (5GC) supporting various functionality, such as managing support for different location services for one or more UEs. For example the LMF 131 may include one or more servers, such as multiple distributed servers. Base stations 105 may forward location messages to the LMF 131 and may communicate with the LMF via a NR Positioning Protocol A (NRPPa).

The LMF 131 is configured to control the positioning parameters for UEs 115 and the LMF 131 can provide information to the base stations 105 and UE 115 so that action can be taken at UE 115. In some implementations, UE 115 and base station 105 are configured to communicate with the LMF 131 via an Access and Mobility Management Function (AMF).

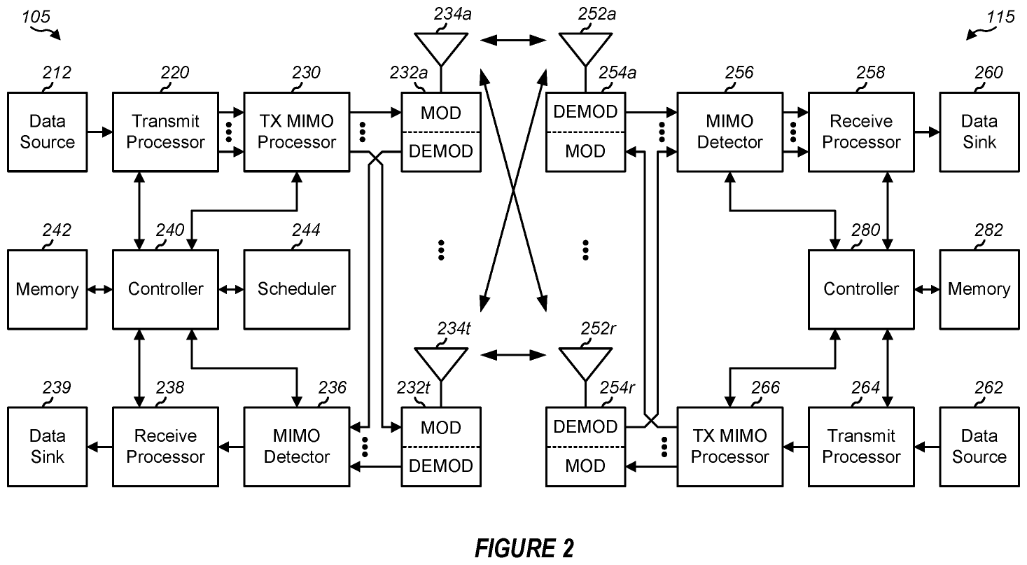

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

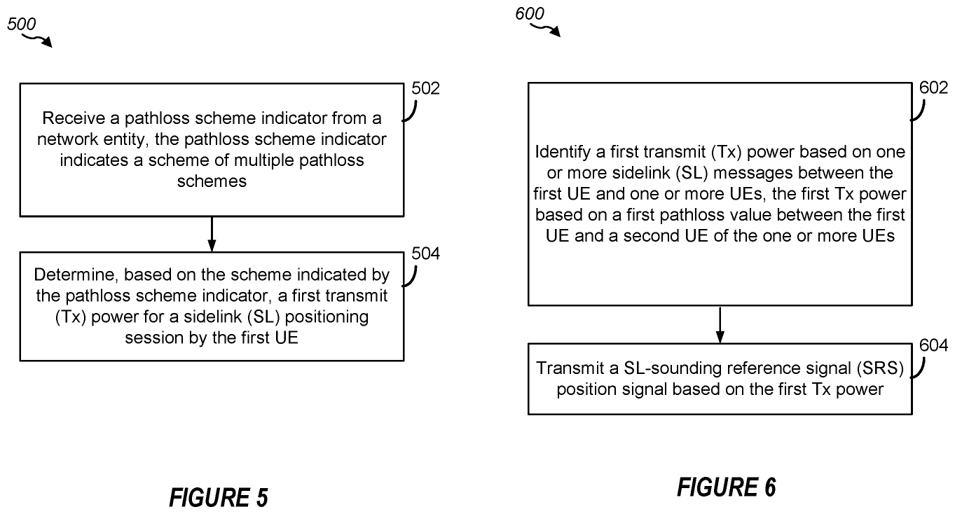

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 5-7 and 9, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

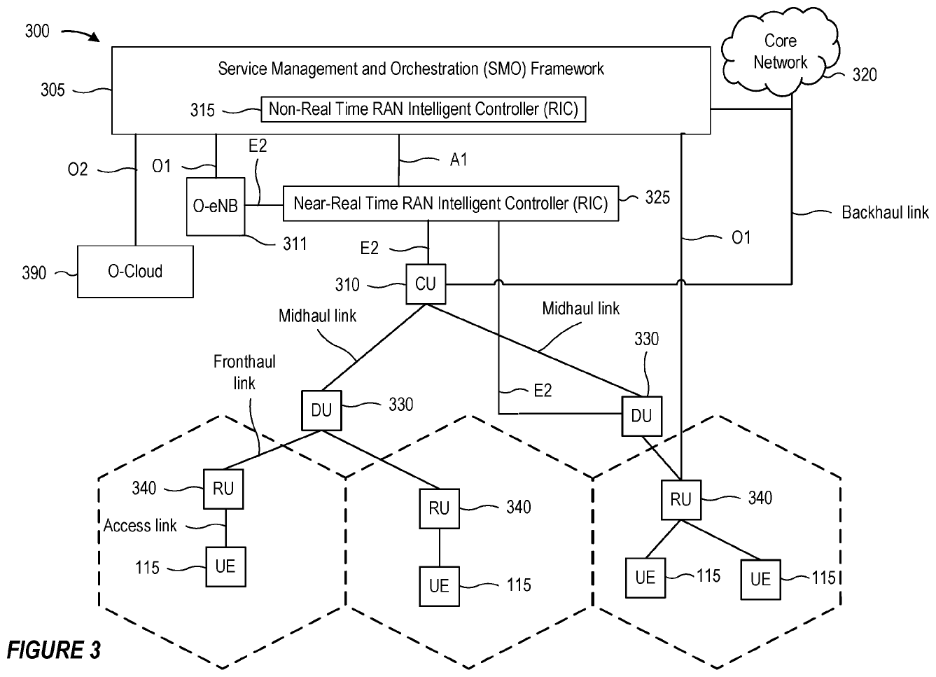

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 115 via one or more radio frequency (RF) access links. In some implementations, the UE 115 may be simultaneously served by multiple RUs 340.

Each of the units, i.e., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 115. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As described herein, a node (which may be referred to as a node, a network node, a network entity, or a wireless node) may include, be, or be included in (e.g., be a component of) a base station (e.g., any base station described herein), a transmission and reception point (TRP), a UE (e.g., any UE described herein), a network controller, an apparatus, a device, a computing system, an integrated access and backhauling (IAB) node, a distributed unit (DU), a central unit (CU), a remote unit (RU), a core network, a LFM, and/or a another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

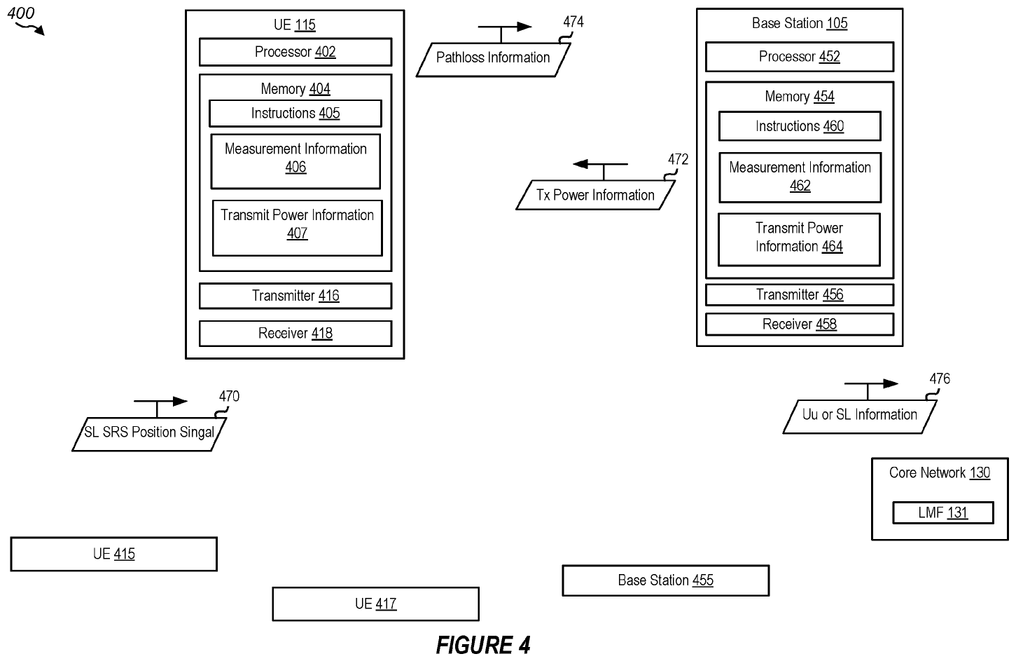

FIG. 4 is a block diagram of an example wireless communications system 400 that supports power control for positioning according to one or more aspects. In some examples, wireless communications system 400 may implement aspects of wireless network 100. Wireless communications system 400 includes UE 115, a UE 415, a UE 41, base station 105, a base station 455, and core network 130. Although three UEs 115 and two base stations, in some other implementations, wireless communications system 400 may include a different number of UEs, a different number of base stations (e.g., zero, one, or more than one base station, or a combination thereof. In some implementations, wireless communication system 400 may include one or more TRPs.

UE 115 may be configured to perform Uu communication, SL communication, or a combination thereof. UE 115 may include a variety of components (such as structural, hardware components) used for carrying out one or more functions described herein. For example, these components may include one or more processors 402 (hereinafter referred to collectively as “processor 402”), one or more memory devices 404 (hereinafter referred to collectively as “memory 404”), one or more transmitters 416 (hereinafter referred to collectively as “transmitter 416”), and one or more receivers 418 (hereinafter referred to collectively as “receiver 418”). In some implementations, UE 115 may include an interface (e.g., a communication interface) that includes transmitter 416, receiver 418, or a combination thereof. Processor 402 may be configured to execute instructions 405 stored in memory 404 to perform the operations described herein. In some implementations, processor 402 includes or corresponds to one or more of receive processor 258, transmit processor 264, and controller 280, and memory 404 includes or corresponds to memory 282.

Memory 404 includes or is configured to store instructions 405, measurement information 406, and transmit power information. Measurement information 406 may include or indicate information associated with one or more received signals or waveforms, such as one or more signals or waveforms received by UE 115, one or more signals or waveforms received by another device, such as UE 415, UE 417, base station 105, or base station 455. To illustrate, for a received signal or waveform, measurement information 406 may include or indicate an error rate, a reference signal received power (RSRP), a received signal strength (RSS), a received signal strength indicator (RSSI), a reference signal received quality (RSRQ), or a combination thereof.

Transmit power information 407 may include or correspond to a Tx power for Uu communication, a Tx power for SL communication, a change in Tx power, an increase or decrease in Tx power, a Tx power change amount, a pathloss value (e.g., a UE-UE pathloss value, a UT-TRP pathloss value, or a combination thereof), a SRS configuration associated with SL communication, a scheme of multiple pathloss schemes, a set of one or more UEs, a set of one or more base stations, a set of one or more TRPs, position information, or a combination thereof. In some implementations, transmit power information 407 may include or indicate one or more UE capabilities or UE parameters, such as a UE power level.

Transmitter 416 is configured to transmit reference signals, control information and data to one or more other devices, and receiver 418 is configured to receive references signals, synchronization signals, control information and data from one or more other devices. For example, transmitter 416 may transmit signaling, control information and data to, and receiver 418 may receive signaling, control information and data from, base station 105. In some implementations, transmitter 416 and receiver 418 may be integrated in one or more transceivers. Additionally or alternatively, transmitter 416 or receiver 418 may include or correspond to one or more components of UE 115 described with reference to FIG. 2.

UE 415 may include one or more components as described herein with reference to UE 115. Additionally, UE 415 may be configured to perform one or more operations as described herein with reference to UE 115.

UE 417 may include one or more components as described herein with reference to UE 115. Additionally, UE 417 may be configured to perform one or more operations as described herein with reference to UE 115 or UE 415.

Base station 105 may include a variety of components (such as structural, hardware components) used for carrying out one or more functions described herein. For example, these components may include one or more processors 452 (hereinafter referred to collectively as “processor 452”), one or more memory devices 454 (hereinafter referred to collectively as “memory 454”), one or more transmitters 456 (hereinafter referred to collectively as “transmitter 456”), and one or more receivers 458 (hereinafter referred to collectively as “receiver 458”). In some implementations, base station 105 may include an interface (e.g., a communication interface) that includes transmitter 456, receiver 458, or a combination thereof. Processor 452 may be configured to execute instructions 460 stored in memory 454 to perform the operations described herein. In some implementations, processor 452 includes or corresponds to one or more of receive processor 238, transmit processor 220, and controller 240, and memory 454 includes or corresponds to memory 242.

Memory 454 includes or is configured to store instructions 460, measurement information 462, and transmit power information 464. Measurement information 462 may include or correspond to measurement information 406. Measurement information 462 may include or indicate information associated with one or more received signals or waveforms, such as one or more signals or waveforms received by base station 105, one or more signals or waveforms received by another device, such as UE 115, UE 415, UE 417, or base station 455. To illustrate, for a received signal or waveform, measurement information 462 may include or indicate an error rate, a RSRP, an RSS, an RSSI, an RSRQ, or a combination thereof.

Transmit power information 464 may include or correspond to a Tx power for Uu communication, a Tx power for SL communication, a change in Tx power, an increase or decrease in Tx power, a Tx power change amount, a pathloss value (e.g., a UE-UE pathloss value, a UT-TRP pathloss value, or a combination thereof), a SRS configuration associated with SL communication, a scheme of multiple pathloss schemes, a set of one or more UEs, a set of one or more base stations, a set of one or more TRPs, position information, or a combination thereof.

Transmitter 456 is configured to transmit reference signals, synchronization signals, control information and data to one or more other devices, and receiver 458 is configured to receive reference signals, control information and data from one or more other devices. For example, transmitter 456 may transmit signaling, control information and data to, and receiver 458 may receive signaling, control information and data from, UE 115. In some implementations, transmitter 456 and receiver 458 may be integrated in one or more transceivers. Additionally or alternatively, transmitter 456 or receiver 458 may include or correspond to one or more components of base station 105 described with reference to FIG. 2 or one or more components of disaggregated base station 300.

Base station 455 may include one or more components as described herein with reference to base station 105. Additionally, base station 455 may be configured to perform one or more operations as described herein with reference base station 105.

Core network 130 may include a 4G core network, a 5G core, an evolved packet core (EPC). Core network may be coupled, such as communicatively coupled, to base station 105 or 455, UE 115, 415, or 417, or a combination thereof. Core network 130 may include or correspond to LMF 131. Although shown and described as being included in core network 130, LMF 131 may be distinct from core network 130 in some implementations. For example the LMF 131 may include one or more servers, such as multiple distributed servers. LMF 131 may be configured to support various functionality, such as managing support for different location services for one or more UEs. For example, LMF 131 is configured to control the positioning parameters for UEs 115 and the LMF 131 can provide information to the base stations 105 and UE 115 so that action can be taken at UE 115. Base stations 105 may forward location messages to the LMF 131 and may communicate with the LMF 131 via a NR Positioning Protocol A (NRPPa). In some implementations, UE 115 and base station 105 are configured to communicate with the LMF 131 via an Access and Mobility Management Function (AMF).

In some implementations, wireless communications system 400 implements a 5G NR network. For example, wireless communications system 400 may include multiple 5G-capable UEs 115, 415, or 417 and multiple 5G-capable base stations 105 or 455, such as UEs and base stations configured to operate in accordance with a 5G NR network protocol such as that defined by the 3GPP.

During operation of wireless communications system 400, a Tx power of a UE, such as UE 115, 415, or 417, for Uu communication, SL communication, may be controlled by the UE or by a base station, such as base station 105 or base station 455. For example, the SL communication may include SL positioning. In some implementations, the Tx power of the UE may be jointly controlled for Uu communication and SL communication (e.g., SL positioning). In some implementations, the UE may determine the Tx power based on an SL pathloss value, feedback from another UE that participated in SL communication with the UE in SL communication, or a combination thereof.

Additionally, or alternatively, the UE may be configured to adjust the Tx power, a resource allocation (e.g., a number of symbols per SL positioning instance of an SL positioning session), or a combination thereof. For example, in some implementations, the feedback associated with the SL communication may enable the UE to adjust the Tx power, a resource allocation (e.g., a number of symbols per SL positioning instance of an SL positioning session), or a combination thereof. In some implementations, a base station may be configured to receive or determine measurements, such as SL channel measurements, Uu channel measurements, or a combination thereof, and signal or configure the Tx power for one or more UEs. To illustrate, the measurements may include or correspond to a pathloss estimate or a pathloss value, and the base station may determine the Tx power based on the pathloss estimate or the pathloss value. In some implementations, operations described herein may be associated with or correspond to a UE that is in coverage or out of coverage with a base station—e.g., within a coverage area of the base station or out of the coverage area of the base station.

In some implementations, UE 115 may determine a Tx power for SL communication during a discovery phase, such as an SL discovery phase. For example, the Tx power associated with the SL communication may be a Tx power for SL positioning, such as a Tx power for an SL SRS positioning signal 470. The discovery phase may or may not be part of an SL position session. UE 115 may determine the Tx power for SL communication based on a communication during the discovery phase that is transmitted using a Tx power—e.g., transmitted by UE 115 using a Tx power known to one or more other UEs or transmitted by another UE (other than UE 115) using a Tx power known to UE 115 and received by UE 115.

In some implementations, UE 115 may be out of coverage with base station 105 and base station 455 when UE 115 determines the Tx power during the discovery phase. To illustrate, UE 115 may receive an SL communication, such as an SL discovery communication, from another UE, such as UE 415 or UE 417. The SL communication received by UE 115 may transmitted, such as by UE 415 or UE 417, using a Tx power that is known to UE 115. For example, the Tx power may be determined or established during the discovery phase or may be defined by a standard. UE 115 may determine the Tx power for SL positioning based on the received SL communication transmitted using the known Tx power. For example, the SL communication may be received from UE 415 and UE 115 may determine a pathloss value of an SL channel between UE 115 and UE 415 based on the received SL communication, the Tx power to transmit the SL communication, or a combination. To illustrate, UE 115 may determine a received signal strength (RSS) based on the received SL communication and may determine the pathloss value associated with the SL communication channel based on the RSS and the Tx power to transmit the SL communication. In some implementations, the pathloss value may be an estimated pathloss value. UE 115 may determine the Tx power associated with the SL communication (e.g., the Tx power for SL positioning) based on the pathloss value. UE 115 may transmit SL SRS positioning signal 470 using the determined Tx power. For example, UE 115 may transmit SL SRS positioning signal 470 to one or more UEs from which UE 115 received an SL communication, such as an SL communication received during the discovery phase.

In some implementations, UE 115 may receive multiple SL communications (each transmitted using a known Tx power) during the discovery phase and may determine the Tx power for SL positioning based the received multiple SL communications. To illustrate, UE 115 may determine a pathloss value of the multiple received SL communications as an maximum pathloss value, a minimum pathloss value, an average pathloss value, a mode pathloss value, a median pathloss value, a range of pathloss values, or a combination thereof. As an illustrative example, UE 115 may receive a first SL communication from UE 415 and a second SL communication from UE 417. UE 115 may determine a first pathloss value associated with UE 415 and may determine a second pathloss value associated with UE 417. UE 115 may determine the Tx power for SL positioning based on the first pathloss value, the second pathloss value, or a combination thereof. UE 115 may transmit SL SRS positioning signal 470 using the determined Tx power. For example, UE 115 may transmit SL SRS positioning signal 470 to one or more UEs from which UE 115 received an SL communication, such as an SL communication received during the discovery phase.

In some implementations, the discovery phase may be part of a round trip time (RTT) positioning operation. During the RTT positioning operation, UE 115 may transmit a first message at a first Tx power, such as a high Tx power or a known Tx power. Another UE, such as UE 415, may receive the first message and transmit a second message to UE 115. To illustrate, UE 415 may determine a first pathloss value based on the first Tx power, the first message, an RSS of the first message, or a combination thereof. The first pathloss value may be an estimated pathloss value. In some implementation, UE 415 transmits the second message using a reduced power (as compared to the first Tx power). The reduced power, such as a second Tx power, may be determined by UE 415 based on the first pathloss value associated with the first message. In some implementations, the second message may include or indicate the first pathloss value, the second Tx power, or a combination thereof. UE 115 may transmit one or more additional messages, such as one or more SL positioning signals using a third Tx power that is determined based on the first pathloss value, the second message, the second Tx power, a RSS of the second message, or a combination thereof.

In some implementations, the discovery phase may be part of a double-sided RTT positioning operation. During the double-sided RTT positioning operation, UE 115 may transmit a first message at a first Tx power, such as a high Tx power or a known Tx power. Another UE, such as UE 415, may receive the first message and transmit a second message to UE 115. To illustrate, UE 415 may transmit the second message using the first Tx power, such as a high Tx power or a known Tx power. UE 115 may determine a second Tx power based on the second message transmitted using the first Tx power. For example, UE 115 may determine a pathloss value based on the second message, the first Tx, or a combination. To illustrate, UE 115 may determine an RSS based on the second message and may determine the pathloss value based on the RSS. In some implementations, the pathloss value may be an estimated pathloss value. UE 115 may determine transmit a third message of the double-sided RTT positioning operation using the second Tx power.

In some implementations, UE 115 may determine an SRS configuration for SL communication. In some implementations, UE 115 may be out of coverage with base station 105 and base station 455 when UE 115 determines the SRS configuration for SL communication. The SRS configuration may include or indicate an SL Tx power (e.g., an SL Tx power for SL positioning), a number of symbols (e.g., a number of OFDM symbols per instance), or a combination thereof. In some implementations, a first SRS configuration for SL communication includes or indicates indicating a first Tx power for SL communication and a first number of symbols per SL positioning instance associated with an SL positioning session. UE 115 may transmit SL SRS position signal 470 based on the first SRS configuration. Additionally, or alternatively, UE 115 may receive SL SRS position signal 470 that was transmitted by another UE (e.g., UE 415 or UE 417) based on the first SRS configuration.

In some implementations, a UE, such as UE 115 or UE 415, may be configured to perform joint power and resource adaptation. To illustrate, UE 115 or UE 415 may select or adjust the first SRS configuration to change the SL Tx power, the number of symbols, or a combination thereof. For example, the UE may increase the number of symbols such that an SL SRS position signal (e.g., 470) has a greater range, increase the SL Tx power such that an SL SRS position signal (e.g., 470) has a greater range, or a combination thereof.

In some implementations, UE 115 may establish one or more resource and power configurations with another UE, such as UE 415, during an SL connection setup or an SL discovery phase. To illustrate, during the SL connection setup or the SL discovery phase, UE 115 and UE 415 may agree on one or more resource and power configurations. One of UE 115 or UE 415 may signal a choice of a first SRS configuration based on the one or more resource and power configurations. For example, the first SRS configuration may be signaled using an RRC that is unicast, multicast, or groupcast. After transmission of the indication of selection of the first SRS configuration, UE 115 may transmit or receive SL SRS position signal 470 based on the first SRS configuration.

After the first SRS configuration is signaled, UE 115 and UE 415 may perform SL communication, such as SL positioning, based on the first SRS configuration. In some implementations, UE 115 or UE 415 may change the SRS configuration to a second SRS configuration. For example, UE 115 may select or determine the second SRS configuration based on the one or more resource and power configurations agreed upon by UE 115 and UE 415. UE 115 may signal selection of the second SRS configuration to UE 415. For example, the second SRS configuration may be signaled using an MAC-CE that is unicast, multicast, or groupcast. The MAC-CE may be configured for SL position (e.g., SL power control) and may be independent of data power control. After transmission of an indication of selection of the second SRS configuration, UE 115 may transmit or receive SL SRS position signal 470 based on the first SRS configuration.

In some implementations, such as when one or more UEs are within coverage of a base station (e.g., 105), the base station may receive SL pathloss values from one or more UEs and determine a Tx power for the one or more UEs. For example, the SL pathloss values may include or correspond to pathloss information 474. The Tx power may be for Uu communication, sidelink communication (e.g., SL positioning), or both Uu and SL communication. The base station may indicate the Tx power to the one or more UEs. For example, the Tx power may be included or indicated by Tx power information 472.

In some implementations, a UE may determine or estimate a pathloss value for one or more other UEs and sends the pathloss value to the base station. To illustrate, UE 115 may determine a first pathloss value associated with UE 415 and a second pathloss value associated with UE 417. For example, UE 115 may determine the first pathloss value and the second pathloss value based on an SL connection setup, an SL discovery phase, or an SL positioning session, such as an SL instance of the SL positioning session. In some implementations, the first pathloss value or the second pathloss value may be an estimate pathloss value. UE 115 may generate and transmit pathloss information 474 that includes or indicates the first pathloss value, the second pathloss value, a third pathloss value based on the first pathloss value and the second pathloss value, or a combination thereof. In some implementations, pathloss information 474 may include or correspond to measurement information 406, transmit power information 407, or a combination thereof. Base station 105 may receive pathloss information 474 and determine the Tx power (e.g., for Uu communication, SL communication, or both) for the one or more UEs, such as UE 115, UE 415, UE 417, or a combination thereof.

In some implementations, multiple UEs may be configured to perform a position session that includes multiple instances of positioning signaling, such as periodic instances or sequential instance. Additionally, or alternatively, the multiple UEs may be configured to perform periodic positioning sessions that each include one or more instances. In a first or initial positioning instance, UE 115 may be configured to use a default transmit power to transmit SL SRS position signal 470. At the end of the first or initial instance, one or more UEs, such as UE 415 or UE 417, that received SL SRS position signal 470 report back to UE 115 a value or an indication of an SRS position measurement, an RSRP of the received SL SRS position signal 470, or a combination thereof. UE 115 may include the information received from the one or more UEs and include the information in pathloss information 474 that UE 115 sends to base station 105. Base station 105 may receive the pathloss information 474 and determine a pathloss value for each UE SL channel, e.g., ah UE-UE link pathloss value. Additionally, base station 105 may monitor the transmission by the one or more UEs and determine a pathloss value between each UE and base station 105, such as UL pathloss value.

Base station 105 may determine a Tx power (for Uu communication, sidelink communication, or both Uu and SL communication) for the one or more UEs based on one or more UE-UE link pathloss values, one or more UL pathloss values, or a combination thereof. For example, base station 105 may determine the Tx power for UE 115, UE 415, UE 417, or a combination thereof. Base station 105 may transmit Tx power information that includes or indicates the Tx power for the one or more UEs. In some implementations, each of the one or more UEs receives Tx power information 472. Tx power information 472 may include or indicate a single Tx power for each of the one or more UEs or may include or indicate, for each of the one or more UEs, a corresponding Tx power for the UE. The one or more UEs may use the Tx power for subsequent positioning instances of the SL positioning session.

In some implementations, the above techniques for the in coverage UEs may be repeated for one or more positioning instances, such as each positioning instance, every other positioning instance, a set of positioning instances, etc. To illustrate, the above techniques may be applied or repeated for another positioning instance (e.g., a second positioning instance) after the first positioning instance. The one or more UEs may report RSRP values associated with the second positioning instance and base station 105 may update the Tx power of the one or more UEs. Base station 105 may transmit the updated Tx power to the one or more UEs. For example, base station 105 may transmit Tx power information 472 that includes or indicates the updated Tx power. In some implementations, Tx power information 472 may include a Transmit Power Control (TPC) command. Additionally, or alternatively, Tx power information 472 can be communicated to the one or more UEs via RRC, MAC CE, or DCI.

In some implementations, to update the Tx power, Tx power information 472 may include or indicate the updated power value. Additionally, or alternatively, Tx power information 472 may include or indicate a power increment/decrement value, an increment/decrement step size, or a combination thereof. Additionally, or alternatively, Tx power information 472 may indicate an adjustment value of +/−x dB, where x can belong to a predefined range. In some implementations, to minimize signaling overhead, x can be only a single defined value and Tx power information 472 may include a single bit to indicate whether to increment (e.g., a bit value of 1) or decrement (e.g., a bit value of 0). It is noted that if base station 105 determines to maintain the Tx power (e.g., not update the Tx power), base station 105 does not sent Tx power information 472.

In some implementations, such as when a UE is within coverage of a base station (e.g., 105), the base station may indicate a scheme (of one or more schemes) for the UE to determine Tx power for SL positioning, such as an SP SRS position signal transmit power. For example, base station 105 may select a pathloss scheme of multiple pathloss schemes for UE 115. Base station 105 may transmit Tx power information 472 that includes a pathloss scheme indicator of the selected scheme. The multiple pathloss schemes may include an SL pathloss scheme, a UL pathloss scheme, a joint SL and UL pathloss scheme, or a combination thereof. UE 115 may receive Tx power information 472 and determine a scheme indicated by the pathloss scheme indicator.

In some implementations, the pathloss scheme indicator may indicate the SL pathloss scheme. For the SL pathloss scheme, UE 115 may be configured to determine a Tx power for SL communication during a discovery phase (e.g., an SL discovery phase), based on RTT, or based on a double-sided RTT, as described above.

In some implementations, the pathloss scheme indicator may indicate the UL pathloss scheme. For the UL pathloss scheme, UE 115 may be configured to identify or determine a Uu link pathloss and determine the Tx power for SL positioning based on the Uu link pathloss. For example, UE 115 may account for one or more Uu links pathlosses and the Tx power for SL positioning independent of one or more SL links (e.g., pathloss of the one or more SL links). It is noted that another UE (e.g., UE 415 or UE 417) that performs SL communication, such as SL positioning, with UE 115, may be configured with a guard symbol to enable the other UE to adjust its automatic gain control (AGC). Accordingly, even if UE 115 determines a Tx power for SL positioning based on the Uu link pathloss, the other UE may be able to adjust and perform SL positioning with UE 115 even if the Tx power used for SL positioning is higher than the other UE expects for SL communication.

In some implementations, the pathloss scheme indicator may indicate the joint SL and UL pathloss scheme. For the joint SL and UL pathloss scheme, UE 115 may be configured to determine the Tx power for SL positioning based on a set of one or more TRPs, a set of one or more UEs, or a combination thereof. The set of one or more TRPs may be selected by UE 115 or selected by base station 105 and indicated to UE 115 using Tx power information 472. Additionally, or alternatively, the set of one or more UEs may be selected by UE 115 or selected by base station 105 and indicated to UE 115 using Tx power information 472. For each of the one or more TRPs or for each of the one or more UEs, UE 115 may determine a corresponding pathloss values, such as a UE-TRP pathloss value or a UE-UE pathloss value. UE 115 may determine the TX power for SL communication (e.g., SL positioning) based on the UE-TRP pathloss value(s), the UE-UE pathloss value(s), or a combination thereof.

It is noted that the scheme selected or indicated by base station 105 prioritize a certain type of positioning measurements. For example, the UL pathloss scheme may prioritize network based measurements over SL based measurements. As another example, the SL pathloss scheme may prioritize SL based measurements over network based measurements. Additionally, in the SL pathloss scheme, the SL links are optimized and Uu links may be used on a best effort basis-which may be possible based on a TRP or base station having processing capabilities and can receive or monitor a SL link at lower receive power (e.g., multi-antenna processing gains). As another example, the joint SL and UL pathloss scheme may prioritize a balance between SL based measurements and network based measurements.

In some implementation, base station 105 may indicate Tx power for SL positioning for UE 115 and UE 415. For example, a first Tx power for UE 115 and a second Tx power for UE 415 may be indicated using Tx power information 472. In some implementations, UE 115 and UE 415 may have locations that are unknown to base station 105. Positioning may be performed by UE 115, UE 415 or both based on the first Tx power and the second Tx power. In some implementations, the positioning may be performed using SL SRS position signaling. It is noted that base station 105 may be configured to monitor a SL channel to detect and measure one or more SL SRS position signals.

In some implementations, the first Tx power may be high power to enable the SL SRS position signal transmitted by UE 115 to be received by one or more TRPs, such as base station 105. In contrast, the second Tx may be low power such that the SL SRS position signal transmitted by UE 415 may server to estimate a range (e.g., distance and angle) between UE 115 and UE 415, but may not be receive by the one or more TRPs.

Base station 105 may receive or determine pathloss information (e.g., UE-UE pathloss value(s), UE-TRP pathloss value(s), or a combination thereof) based on the SL SRS position signal transmitted by UE 115 and the SL SRS position signal transmitted by UE 415. Based on the SL SRS position signals of UEs 115 and 415, the pathloss information, or a combination thereof, base station 105 may determine a position of UE 115, UE 415, or a combination thereof. In some implementations, base station 105 may combine the received signals coming from both transmissions and determine the location of both UEs 115 and 415 simultaneously. By determining and indicating the Tx powers for SL positioning to UE 115 and UE 415, base station 105 is able to cause only one UE to transmit at a high power and limit network interference and power consumption.

In some implementation, one or more operations described herein may be performed by core network 130, LMF 131, or a combination. To illustrate, to enable the one or more operations at core network 130 or LMF 131, base station 105 may transmit Uu or SL information 476 to core network or LMF 131. Uu or SL information 476 may include or correspond to measurement information 462, transmit power information, Tx power information 472, pathloss information 474, or a combination thereof. Core network 130 or LMF 131 may be configured to perform at least one operation based on Uu or SL information 476. The at least one operation may include or correspond to an operation described herein at least with reference to base station 105 or base station 455. Additionally, core network or LMF 131 may be configured to transmit additional information to base station 105, base station 455, UE 115, UE 415, UE 417, or a combination thereof. The additional information may include or correspond to Tx power information 472. For example, the additional information may include or indicate a Tx power for Uu communication, a Tx power for SL communication, a change in Tx power, an increase or decrease in Tx power, a Tx power change amount, a pathloss value (e.g., a UE-UE pathloss value, a UT-TRP pathloss value, or a combination thereof), a SRS configuration associated with SL communication, a scheme of multiple pathloss schemes, a set of one or more UEs, a set of one or more base stations, a set of one or more TRPs, position information, or a combination thereof.

As described with reference to FIG. 4, the present disclosure provides techniques for power control for positioning. The techniques may for power control for positioning, such as SL positioning, Uu positioning, or both SL positioning and Uu positioning may allow or enable optimized positioning sessions involving both PC5 and Uu links. For example, base station 105, core network 130, or LMF 131 may optimize one or more positioning session including PC5 links, Uu links, or a combination thereof. Additionally, determining and signaling an appropriate power value that optimizes the received signals over both Uu and PC5 link can improve the received signals qualities, a final positioning estimate, or a combination thereof. The techniques may also reduce UE power by selecting Tx power for SL communication that is optimized for positioning sessions, based on a current UE power status, or a combination thereof.

FIG. 5 is a flow diagram illustrating an example process 500 that supports power control for positioning according to one or more aspects. Operations of process 500 may be performed by a UE, such as UE 115 described above with reference to FIGS. 1-4, UE 415, UE 417, or a UE described with reference to FIG. 8. For example, example operations (also referred to as “blocks”) of process 500 may enable UE 115 to support power control for positioning.

In block 502, the UE receives a pathloss scheme indicator from a network entity. For example, the network entity may include or correspond to core network 130, LMF 131, one or more components of disaggregated base station 300, base station 105, base station 455, or a TRP. Additionally, or alternatively, the pathloss scheme indicator may include or correspond to Tx power information 472. The pathloss scheme indicator may indicate a scheme of multiple pathloss schemes. For example, the multiple pathloss schemes may include an SL pathloss scheme, a UL pathloss scheme, a joint SL and UL pathloss scheme, or a combination thereof.

In block 504, the UE determines, based on the scheme indicated by the pathloss scheme indicator, a first Tx power for an SL positioning session by the first UE. The first TX power may include or correspond to transmit power information 407. In dome implementations, during the SL positioning session, the UE may transmit an SL SRS position signal, such as SL SRS position signal 470.

In some implementations, the one scheme indicated by the indicator includes an SL pathloss scheme. The process 500 may further include the UE performing an SL discovery phase with one or more UEs. During the SL discovery phase, for each UE of the one or more UEs, the UE may receive a first message from the UE. The first message may transmitted by the UE using a second Tx power. In some implementations, the second Tx power is a default Tx power, such as a Tx power defined by a standard. Additionally, during the SL discovery phase, for each UE of the one or more UEs, the UE may determine a receive power associated with the first message from the UE, and determine a pathloss value based on the first message from the UE. determining the first Tx power based on the pathloss value of the one or more UEs.

In some implementations, the one scheme indicated by the indicator includes a UL pathloss scheme. The process 500 may further include the UE determining, for each of one or more TRPs, a pathloss value based on Uu communication between the first UE and the TRP. The one or more TRPs may include or correspond to base station 105, base station 455, or a combination thereof. The pathloss value may include or correspond to measurement information 406. Additionally, the UE may determine the first Tx power based on the pathloss value of the one or more TRPs and independent of SL communication the first UE.

In some implementations, the one scheme indicated by the indicator includes a joint SL and UL pathloss scheme. The process 500 may further include the UE determining first pathloss information based on Uu communication between the first UE and a set of one or more TRPs. The first pathloss information may include or correspond to measurement information 406. The set of one or more TRPs may include or correspond to base station 105, base station 455, another TRP, or a combination thereof. The set of one or more TRPs may be selected from a set of one or more available TRPs by the UE or selected by a network entity, such as base station 105, base station 455, core network 130, or LMF 131, and indicated to the UE. The UE may also determine second pathloss information based on SL communication between the first UE and a set of one or more UEs. The second pathloss information may include or correspond to measurement information 406. The set of one or more UEs may include or correspond to UE 415, UE 417, another UE, or a combination thereof. The UE may determine the first Tx power based on the first pathloss information, the second pathloss information, or a combination thereof. In some implementations, the UE may determine the first Tx power based on the first pathloss information and the second pathloss information. The set of one or more UEs may be selected from a set of one or more available UEs by the UE or selected by a network entity, such as base station 105, base station 455, core network 130, or LMF 131, and indicated to the UE.

FIG. 6 is a flow diagram illustrating an example process 600 that supports power control for positioning according to one or more aspects. Operations of process 600 may be performed by a UE, such as UE 115 described above with reference to FIGS. 1-4, UE 415, UE 417, or a UE described with reference to FIG. 8. For example, example operations (also referred to as “blocks”) of process 600 may enable UE 115 to support power control for positioning.

In block 602, the UE identifies a first Tx power based on one or more SL messages between the first UE and one or more UEs. The first Tx power may include or correspond to transmit power information 407. The one or more UEs may include or correspond to UE 415, UE 417, another UE, or a combination thereof. The first Tx power may be based on a first pathloss value between the first UE and a second UE of the one or more UEs. The first pathloss value may include or correspond to measurement information 406.

In block 604, the UE transmits an SL SRS position signal based on the first Tx power. For example, the SL SRS position signal may include or correspond to SL SRS position signal 470. The SL SRS position signal may be unicast, multicast, or broadcast.

In some implementations, the UE may perform an SL discovery phase with the one or more UEs. During the SL discovery phase, the UE may, for each UE of the one or more UEs, receive a first message from the UE. The first message may be transmitted using a second Tx power. In some implementations, the second Tx power is a default Tx power, such as a Tx power defined by a standard. Additionally, the UE may, for each UE of the one or more UEs, determine a receive power associated with the first message from the UE, and determine a pathloss value based on the first message from the UE. The received power or the pathloss value may include or correspond to measurement information 406. In some implementations, to identify the first TX power, the UE may determine the first Tx power based on at least one pathloss value associated with the one or more UEs. To illustrate, the first pathloss may be determined as a maximum, a minimum, or an average based on the at least one pathloss value associated with the one or more UEs.

In some implementations, the one or more SL messages are associated with an RTT positioning operation. The process 600 may further include the UE performing the RTT positioning operation with the second UE. During the RTT positioning operation, the UE may transmit a first message of the one or more SL messages. The first message may be transmitted based on a second Tx power to the second UE. In some implementations, the second Tx power is a default Tx power, such as a Tx power defined by a standard. Additionally, during the RTT positioning operation, the UE may receive, from the second UE, a second message of the one or more SL messages. The message received from the second UE (i.e., the message transmitted by the second UE) may be transmitted using a third Tx power based on the first pathloss value associated with the first message. The UE may identify the first TX power based on the second message. To illustrate, the second messages may indicate the first pathloss value, the third Tx power, or a combination thereof.

In some implementations, the one or more SL messages are associated with a double-sided RTT positioning operation. The process 600 may further include the performing the double-sided RTT positioning operation with the second UE. During the double-sided RTT positioning operation, the UE may transmit a first message of the one or more SL messages. The first message may be transmitted based on a second Tx power to the second UE. In some implementations, the second Tx power is a default Tx power, such as a Tx power defined by a standard. Additionally, during the double-sided RTT, the UE may receive, from the second UE, a second message of the one or more SL messages. The second message received from the second UE (i.e., transmitted by the second UE) may be transmitted using or based on the second Tx power. The UE may determine the first pathloss value based on the second Tx power, the second message, or a combination thereof. In some implementations, to identify the first TX power, the UE may determine the first Tx power based on the first pathloss value.

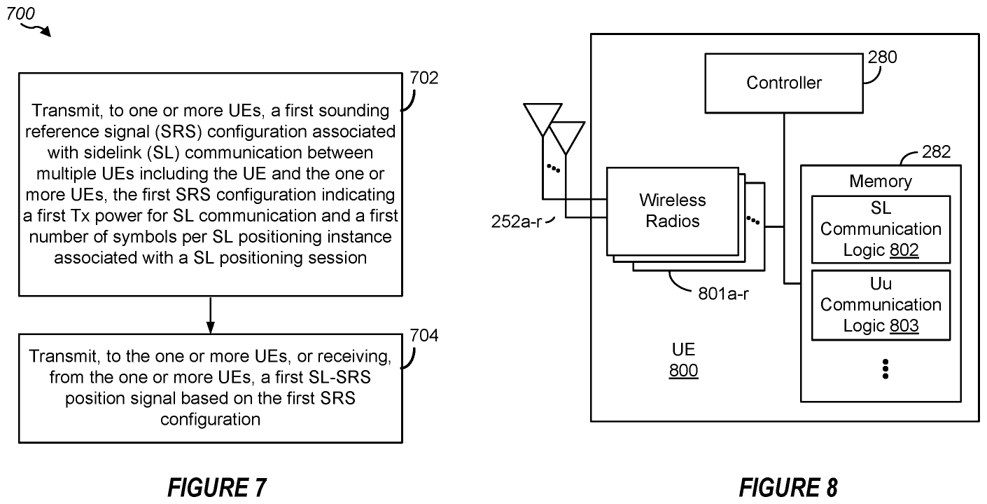

FIG. 7 is a flow diagram illustrating an example process 700 that supports power control for positioning according to one or more aspects. Operations of process 700 may be performed by a UE, such as UE 115 described above with reference to FIGS. 1-4, UE 415, UE 417, or a UE described with reference to FIG. 8. For example, example operations (also referred to as “blocks”) of process 700 may enable UE 115 to support power control for positioning.

In block 702, the UE transmits, to one or more UEs, a first SRS configuration associated with SL communication between multiple UEs including the UE and the one or more UEs. The first SRS configuration may include or correspond to transmit power information 407. The one or more UEs may include or correspond to UE 415, UE 417, another UE, or a combination thereof. The first SRS configuration may indicate a first Tx power for SL communication and a first number of symbols per SL positioning instance associated with an SL positioning session. In some implementations, the first SRS configuration is unicast, multicast, or broadcast.

In block 704, the UE transmits, to the one or more UEs, or receives, from the one or more UEs, a first SL SRS position signal based on the first SRS configuration. For example, the UE may transmit the first SL SRS position signal to the one or more UEs. As another example, the UE may receive the first SL SRS position signal from the one or more UEs. The first SL SRS position signal may include or correspond to SL SRS position signal 470. In some implementations, the first SL SRS position signal is unicast, multicast, or broadcast.

In some implementations, the UE may, during a connection set up or discovery phase associated with the SL communication between the UE and the one or more UEs, determine one or more candidate Tx power configurations for SL communication and one or more candidate number of symbols per SL positioning instance. The one or more candidate Tx power configuration or the one or more candidate number of symbols per SL positioning instance may include or correspond to transmit power information 407.

The one or more candidate Tx power configurations and the one or more candidate number of symbols per SL positioning instance may be acceptable to the UE and the one or more UEs. For example, the UE and the one or more UEs may negotiate the one or more candidate Tx power configurations and the one or more candidate number of symbols per SL positioning instance during the connection set up or the discovery phase.

In some implementations, during the connection set up phase or the discovery phase, the UE may select the first SRS configuration based on the one or more candidate Tx power configurations and the one or more candidate number of symbols per SL positioning instance. Additionally, to transmit the first SRS configuration, the UE may also transmit, such as unicast or groupcast, an RRC that indicates the first SRS configuration.

In some implementations, the UE may transmit, to the one or more UEs, or receive, from the one or more UEs, a second SRS configuration associated with the SL communication. For example, the UE may transmit the second SRS configuration to the one or more UEs. As another example, the UE may receive the second SRS configuration from the one or more UEs. The second SRS configuration may include or correspond to transmit power information 407. The second SRS configuration may indicate a second Tx power different from the first Tx power or a second number of symbols per SL positioning instance associated with the SL positioning session. For example, the second SRS configuration may indicate a second Tx power different from the first Tx power and a second number of symbols per SL positioning instance associated with the SL positioning session. The second number of symbols may be different from the first number of symbols. Additionally, the UE may transmit, to the one or more UEs, or receive, from the one or more UEs, a second SL SRS position signal based on the second SRS configuration. For example, the UE may transmit the second SL SRS position signal to the one or more UEs. As another example, the UE may receive the second SL SRS position signal from the one or more UEs. In some implementations, the second SL SRS position signal is unicast or groupcast.

In some implementations, to transmit, to the one or more UEs, or receive, from the one or more UEs, the second SRS configuration, the UE may transmit or receive an MAC-CE that indicates the second SRS configuration. For example, the UE may transmit the MAC-CE that includes or indicates the second SRS configuration. As another example, the UE may receive the MAC-CE that includes or indicates the second SRS configuration. Additionally, the MAC-CE may be unicast or groupcast.

FIG. 8 is a block diagram of an example UE 800 that supports power control for positioning to one or more aspects. UE 800 may be configured to perform operations, including the blocks of one or more processes described with reference to FIGS. 5-7. In some implementations, UE 800 includes the structure, hardware, and components shown and described with reference to UE 115 of FIGS. 1-4. For example, UE 800 includes controller 280, which operates to execute logic or computer instructions stored in memory 282, as well as controlling the components of UE 800 that provide the features and functionality of UE 800. UE 800, under control of controller 280, transmits and receives signals via wireless radios 801a-r and antennas 252a-r. Wireless radios 801a-r include various components and hardware, as illustrated in FIG. 2 for UE 115, including modulator and demodulators 254a-r, MIMO detector 256, receive processor 258, transmit processor 264, and TX MIMO processor 266.

As shown, memory 282 may include SL communication logic 802, Uu communication logic 803, or a combination thereof. SL communication logic 802 may be configured to enable UE 800 to perform one or more SL communication operations with a another UE. For example, SL communication logic 802 may be configured to determine or identify a pathloss scheme, identify or determine a Tx power based on one or more SL messages, or determine or identify a SRS configuration associated with SL communication. For example, SL communication logic 802 may be configured to determine or identify a pathloss scheme as described herein at least with reference to FIG. 4 or 5. As another example, SL communication logic 802 may be configured to identify or determine a Tx power based on one or more SL messages as described herein at least with reference to FIG. 4 or 6. As another example, SL communication logic 802 may be configured to determine or identify a SRS configuration associated with SL communication as described herein at least with reference to FIG. 4 or 7. Uu communication logic 803 may be configured to enable UE 800 to perform one or more Uu communication operation with a network entity, such as a based station, a TRP, a core network, or a LMF. UE 800 may receive signals from or transmit signals to one or more network entities, such as base station 105 of FIGS. 1-4, base station 455 of FIG. 4, core network 130 of FIG. 1 or 4, LMF 131 of FIG. 1 or 4, a TRP, or a base station as illustrated in FIG. 10. Additionally, or alternatively, memory 282 may include

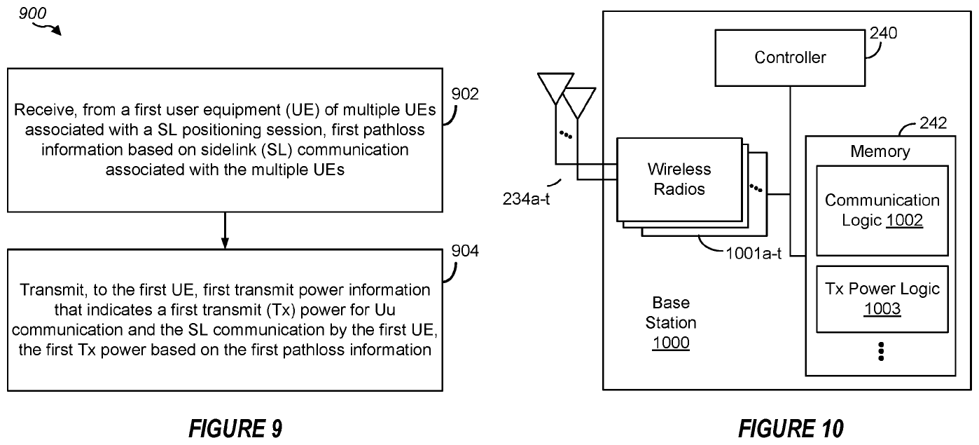

FIG. 9 is a flow diagram illustrating an example process 900 that supports power control for positioning according to one or more aspects. Operations of process 900 may be performed by a base station, such as base station 105 described above with reference to FIG. 1, 2, or 4, base station 455, disaggregated base station 300, RU 340, a TRP, or a base station as illustrated in FIG. 10. For example, example operations of process 900 may enable base station 105 to support power control for positioning. Although process 900 is described with reference to operations preformed by a base station, in other implementations, process 900, or a portion thereof, may be performed by another network entity, such as core network 130 or LMF 131.

At block 902, the base station receives, from a first UE of multiple UEs associated with an SL positioning session, first pathloss information based on SL communication associated with the multiple UEs. For example, the pathloss information may include or correspond to measurement information 406, transmit power information 407, or pathloss information 474. The multiple UEs may include or correspond to UE 115, UE 415, UE 417, another UE, or a combination thereof. In some implementations, the SL communication includes an SL positioning session.

At block 904, the base station transmits, to the first UE, first transmit power information that indicates a first Tx power for Uu communication and the SL communication by the first UE. The first Tx power may be based on the first pathloss information. The first transmit power information may include or correspond to transmit power information 464, Tx power information 472, or transmit power information 407. In some implementations, the first Tx power information is transmitted to each UE of the multiple UEs.

In some implementations, the first pathloss information indicates, for each other UE of the multiple UEs other than the first UE, an SL pathloss value associated with SL communication between the first UE and the other UE. Additionally, or alternatively, the first pathloss information may be associated with an SL positioning session and may indicate a first RSRP of an SL SRS position signal received by the first UE, a first SL SRS position measurement of the UE and associated with the SL SRS position signal, or a combination thereof. The SL SRS position signal associated with the first pathloss information may have been transmitted based on a default transmit power, such as a default transmit power defined by a standard. In some implementations, the base station may receive, from a second UE of the multiple UEs, second pathloss information based on the SL communication associated with the multiple UEs. The second pathloss information may be associated with the SL positioning session and indicates a second RSRP of the SL SRS position signal received by the second UE, a second SL SRS position measurement of the second UE and associated with the SL SRS position signal, or a combination thereof. The base station may determine the first Tx power based on the first pathloss information, the second pathloss information, or a combination thereof.

In some implementations, the base station estimates, based on the first pathloss information, a UE-UE pathloss value, a UE-TRP pathloss value, or a combination thereof. The base station may determine the first Tx power based on the UE-UE pathloss value, the UE-TRP pathloss value, or a combination thereof.

In some implementations, the base station receives a communication from the first UE. The base station may determine a Uu pathloss value based on the communication. Additionally, the base station may determine the first Tx power based on the first pathloss information and the Uu pathloss value.

In some implementations, the first transmit power information may indicate the first Tx power for at least one SL positioning instances of an SL positioning session associated with the multiple UEs. Additionally, or alternatively, the first transmit power information may indicate the first Tx power for multiple SL positioning instances of an SL positioning session associated with the multiple UEs. In some implementations, the base station may receive, for at least one SL positioning instance of multiple SL positioning instances of an SL positioning session associated with the multiple UEs, pathloss information associated with the at least one SL positioning instance.

In some implementations, the base station receives, from the first UE, second SL pathloss information associated with the first UE and a second UE and based on the first Tx power. The base station may transmit, to the first UE, second transmit power information that indicates a second Tx power for the Uu communication and the SL communication. The second Tx power may be based on the second pathloss information.

In some implementations, the second transmit power information may indicate a change in Tx power from the first Tx power to the second Tx power. For example, the second transmit power information may indicate the second Tx power, to increase or decrease TX power, a Tx power change amount, or a combination thereof. In some implementations, the base station transmits, to the first UE, an RRC, an MAC-CE, or DCI that includes the second transmit power information.

FIG. 10 is a block diagram of an example base station 1000 that supports power control for positioning according to one or more aspects. Base station 1000 may be configured to perform operations, including the blocks of process 900 described with reference to FIG. 9. In some implementations, base station 1000 includes the structure, hardware, and components shown and described with reference to base station 105 of FIG. 1, 2, or 4, or disaggregated base station 300. For example, base station 1000 may include controller 240, which operates to execute logic or computer instructions stored in memory 242, as well as controlling the components of base station 1000 that provide the features and functionality of base station 1000. Base station 1000, under control of controller 240, transmits and receives signals via wireless radios 1001a-t and antennas 234a-t. Wireless radios 1001a-t include various components and hardware, as illustrated in FIG. 2 for base station 105, including modulator and demodulators 232a-t, transmit processor 220, TX MIMO processor 230, MIMO detector 236, and receive processor 238.

As shown, the memory 242 may include communication logic 1002 and Tx power logic 1003. Communication logic 1002 may be configured to perform one or more communication operations, such as one or more Uu communication operations.

Additionally, or alternatively, communication logic 1002 may be configured to monitor for one or more SL communications. Tx power logic 1003 may be configured to determine a Tx power for one or more UEs. The Tx power may be used by the one or more UEs for Uu communication, SL communication (e.g., SL positioning), or a combination thereof. Base station 1000 may receive signals from or transmit signals to one or more UEs, such as UE 115 of FIGS. 1-4, UE 415, UE 417, or UE 800 of FIG. 8.

It is noted that one or more blocks (or operations) described with reference to FIG. 5-7 or 9 may be combined with one or more blocks (or operations) described with reference to another of the figures. For example, one or more blocks (or operations) of FIG. 5 may be combined with one or more blocks (or operations) of FIG. 6. As another example, one or more blocks associated with FIG. 5 may be combined with one or more blocks associated with FIG. 9. As another example, one or more blocks associated with FIG. 5 may be combined with one or more blocks associated with FIG. 7. As another example, one or more blocks associated with FIG. 5-7 or 9 may be combined with one or more blocks (or operations) associated with FIGS. 1-4. Additionally, or alternatively, one or more operations described above with reference to FIGS. 1-4 may be combined with one or more operations described with reference to FIG. 8 or 10.

In one or more aspects, techniques for supporting power control for positioning may include additional aspects, such as any single aspect or any combination of aspects described below or in connection with one or more other processes or devices described elsewhere herein. In a first aspect, techniques for supporting power control for positioning may include receiving, from a first UE of multiple UEs associated with an SL positioning session, first pathloss information based on SL communication associated with the multiple UEs. The techniques may further include transmitting, to the first UE, first transmit power information that indicates a first Tx power for Uu communication and the SL communication by the first UE. The first Tx power may be based on the first pathloss information. In some examples, the techniques in the first aspect may be implemented in a method or process. In some other examples, the techniques of the first aspect may be implemented in a wireless communication device such as a base station, which may include a base station or a component of a base station. In some examples, the wireless communication device may include at least one processing unit or system (which may include an application processor, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include an interface (e.g., a wireless communication interface) that includes a transmitter, a receiver, or a combination thereof. Additionally, or alternatively, the wireless communication device may include one or more means configured to perform operations described herein.

In a second aspect, in combination with the first aspect, the SL communication includes an SL positioning session.

In a third aspect, in combination with one or more of the first aspect or the second aspect, the first Tx power information is transmitted to each UE of the multiple UEs.

In a fourth aspect, in combination with one or more of the first aspect through the third aspect, the first pathloss information indicates, for each other UE of the multiple UEs other than the first UE, an SL pathloss value associated with SL communication between the first UE and the other UE.

In a fifth aspect, in combination with one or more of the first aspect through the fourth aspect, the first pathloss information is associated with an SL positioning session and indicates a first RSRP of an SL SRS position signal received by the first UE, a first SL SRS position measurement of the UE and associated with the SL SRS position signal, or a combination thereof.

In a sixth aspect, in combination with the fifth aspect, the SL SRS position signal is transmitted based on a default transmit power.

In a seventh aspect, in combination with the fifth aspect, the techniques further include receiving, from a second UE of the multiple UEs, second pathloss information based on the SL communication associated with the multiple UEs,

In an eighth aspect, in combination with the seventh aspect, the second pathloss information is associated with the SL positioning session and indicates a second RSRP of the SL SRS position signal received by the second UE, a second SL SRS position measurement of the second UE and associated with the SL SRS position signal, or a combination thereof.

In a ninth aspect, in combination with the eighth aspect, the techniques further include determining the first Tx power based on the first pathloss information, the second pathloss information, or a combination thereof.

In a tenth aspect, in combination with one or more of the first aspect through the ninth aspect, the techniques further include estimating, based on the first pathloss information, a UE-UE pathloss value, a UE-TRP pathloss value, or a combination thereof.

In an eleventh aspect, in combination with the tenth aspect, the techniques further include determining the first Tx power based on the UE-UE pathloss value, the UE-TRP pathloss value, or a combination thereof.

In a twelfth aspect, in combination with one or more of the first aspect through the eleventh aspect, the techniques further include receiving a communication from the first UE.

In a thirteenth aspect, in combination with the twelfth aspect, the techniques further include determining a Uu pathloss value based on the communication.

In a fourteenth aspect, in combination with the thirteenth aspect, the techniques further include determining the first Tx power based on the first pathloss information and the Uu pathloss value.

In a fifteenth aspect, in combination with one or more of the first aspect through the fourteenth aspect, the first transmit power information indicates the first Tx power for multiple SL positioning instances of an SL positioning session associated with the multiple UEs.

In a sixteenth aspect, in combination with one or more of the first aspect through the fifteenth aspect, the techniques further include receiving, for at least one SL positioning instance of multiple SL positioning instances of an SL positioning session associated with the multiple UEs, pathloss information associated with the at least one SL positioning instance.

In a seventeenth aspect, in combination with one or more of the first aspect through the sixteenth aspect, the techniques further include receiving, for each SL positioning instance of multiple SL positioning instances of an SL positioning session associated with the multiple UEs, pathloss information associated with the SL positioning instance.

In an eighteenth aspect, in combination with one or more of the first aspect through the seventeenth aspect, the techniques further include receiving, from the first UE, second SL pathloss information associated with the first UE and a second UE and based on the first Tx power.

In a nineteenth aspect, in combination with the eighteenth aspect, the techniques further include transmitting, to the first UE, second transmit power information that indicates a second Tx power for the Uu communication and the SL communication, the second Tx power based on the second pathloss information.

In a twentieth aspect, in combination with the nineteenth aspect, the second transmit power information indicates a change in Tx power from the first Tx power to the second Tx power.

In a twenty-first aspect, in combination with the nineteenth aspect, the second transmit power information indicates the second Tx power, to increase or decrease TX power, a Tx power change amount, or a combination thereof.

In a twenty-second aspect, in combination with the nineteenth aspect, the techniques further include transmitting, to the first UE, an RRC, an MAC-CE, or DCI that includes the second transmit power information.

In one or more aspects, techniques for supporting power control for positioning may include additional aspects, such as any single aspect or any combination of aspects described below or in connection with one or more other processes or devices described elsewhere herein. In a twenty-third aspect, techniques for power control for positioning may include receiving a pathloss scheme indicator from a network entity, the pathloss scheme indicator indicates a scheme of multiple pathloss schemes. The techniques further include determining, based on the scheme indicated by the pathloss scheme indicator, a first Tx power for an SL positioning session by the first UE. In some examples, the techniques in the twenty-third aspect may be implemented in a method or process. In some other examples, the techniques of the twenty-third aspect may be implemented in a wireless communication device such as a UE, which may include a UE or a component of a UE. In some examples, the wireless communication device may include at least one processing unit or system (which may include an application processor, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include an interface (e.g., a wireless communication interface) that includes a transmitter, a receiver, or a combination thereof. Additionally, or alternatively, the wireless communication device may include one or more means configured to perform operations described herein.

In a twenty-fourth aspect, in combination with the twenty-third aspect, the one scheme indicated by the indicator includes an SL pathloss scheme, a UL pathloss scheme, or a joint SL and UL pathloss scheme.

In a twenty-fifth aspect, in combination with the twenty-third aspect or the twenty-fourth aspect, the one scheme indicated by the indicator includes an SL pathloss scheme.

In a twenty-sixth aspect, in combination with one or more of the twenty-third aspect through the twenty-fifth aspect, the techniques further include performing an SL discovery phase with one or more UEs.

In a twenty-seventh aspect, in combination with the twenty-sixth aspect, the techniques further include, during the SL discovery phase, for each UE of the one or more UEs, receiving a first message from the UE, the first message transmitted by the UE using a second Tx power.

In a twenty-eighth aspect, in combination with the twenty-seventh aspect, the techniques further include, during the SL discovery phase, for each UE of the one or more UEs, determining a receive power associated with the first message from the UE.

In a twenty-ninth aspect, in combination with the twenty-eighth aspect, the techniques further include, during the SL discovery phase, for each UE of the one or more UEs, determining a pathloss value based on the first message from the UE.

In a thirtieth aspect, in combination with the twenty-ninth aspect, the techniques further include determining the first Tx power based on at least one pathloss value of the one or more UEs.

In a thirty-first aspect, in combination with the twenty-third aspect or the twenty-fourth aspect, the one scheme indicated by the indicator includes a UL pathloss scheme.

In a thirty-second aspect, in combination with the twenty-third aspect or the thirty-first aspect, the techniques further include determining, for each of one or more TRPs, a pathloss value based on Uu communication between the first UE and the TRP.

In a thirty-third aspect, in combination with the thirty-second aspect, the techniques further include determining the first Tx power based on the pathloss value of the one or more TRPs and independent of SL communication the first UE.

In a thirty-fourth aspect, in combination with the twenty-third aspect or the twenty-fourth aspect, the one scheme indicated by the indicator includes a joint SL and UL pathloss scheme.

In a thirty-fifth aspect, in combination with the thirty-third aspect, the techniques further include determining first pathloss information based on Uu communication between the first UE and a set of one or more TRPs.

In a thirty-sixth aspect, in combination with the thirty-fifth aspect, the techniques further include determining second pathloss information based on SL communication between the first UE and a set of one or more UEs.

In a thirty-seventh aspect, in combination with the thirty-sixth aspect, the techniques further include determining the first Tx power based on the first pathloss information and the second pathloss information.

In a thirty-eighth aspect, in combination with the thirty-seventh aspect, the set of one or more TRPs is selected from a set of one or more available TRPs by the first UE or selected by the network entity and indicated to the UE.

In a thirty-ninth aspect, in combination with the thirty-eighth aspect or the thirty-eighth aspect, the set of one or more UEs is selected from a set of one or more available UEs by the first UE or selected by the network entity and indicated to the UE.

In one or more aspects, techniques for supporting power control for positioning may include additional aspects, such as any single aspect or any combination of aspects described below or in connection with one or more other processes or devices described elsewhere herein. In a fortieth aspect, techniques for power control for positioning may include identifying a first Tx power based on one or more SL messages between the first UE and one or more UEs. The first Tx power may be based on a first pathloss value between the first UE and a second UE of the one or more UEs. The techniques further include transmitting an SL SRS position signal based on the first Tx power. In some examples, the techniques in the fortieth aspect may be implemented in a method or process. In some other examples, the techniques of the fortieth aspect may be implemented in a wireless communication device such as a UE, which may include a UE or a component of a UE. In some examples, the wireless communication device may include at least one processing unit or system (which may include an application processor, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include an interface (e.g., a wireless communication interface) that includes a transmitter, a receiver, or a combination thereof. Additionally, or alternatively, the wireless communication device may include one or more means configured to perform operations described herein.

In a forty-first aspect, in combination with the fortieth aspect, the techniques further include performing an SL discovery phase with the one or more UEs.

In a forty-second aspect, in combination with the forty-first aspect, the techniques further include, during the SL discovery phase, for each UE of the one or more UEs, receiving a first message from the UE, the first message transmitted by the UE using a second Tx power.

In a forty-third aspect, in combination with the forty-second aspect, the techniques further include determining a receive power associated with the first message from the UE, and determining a pathloss value based on the first message from the UE.

In a forty-fourth aspect, in combination with the forty-third aspect, identifying the first TX power includes determining the first Tx power based on at least one pathloss value associated with the one or more UEs.

In a forty-fifth aspect, in combination with the forty-fourth aspect, the first pathloss is determined as a maximum, a minimum, or an average based on the at least one pathloss value associated with the one or more UEs.

In a forty-sixth aspect, in combination with the fortieth, the techniques further include the one or more SL messages are associated with an RTT positioning operation.

In a forty-seventh aspect, in combination the forty-sixth aspect, the techniques further include performing the RTT positioning operation with the second UE.

In a forty-eighth aspect, in combination with the forty-seventh aspect, the techniques further include, during the RTT positioning operation, transmitting a first message of the one or more SL messages, the first message transmitted based on a second Tx power to the second UE.

In a forty-ninth aspect, in combination with the forty-eighth aspect, the techniques further include, during the RTT positioning operation, receiving, from the second UE, a second message of the one or more SL messages, the message transmitted by the second UE using a third Tx power based on the first pathloss value associated with the first message.

In a fiftieth aspect, in combination with the forty-ninth aspect, the first TX power is identified based on the second message.

In a fifty-first aspect, in combination with the fiftieth aspect, the second messages indicates the first pathloss value, the third Tx power, or a combination thereof.

In a fifty-second aspect, in combination with the fortieth aspect, the one or more SL messages are associated with a double-sided RTT positioning operation.

In a fifty-third aspect, in combination with the fifty-second aspect, the techniques further include performing the double-sided RTT positioning operation with the second UE.

In a fifty-fourth aspect, in combination with the fifty-third aspect, the techniques further include, during the double-sided RTT positioning operation, transmitting a first message of the one or more SL messages, the first message transmitted based on a second Tx power to the second UE.

In a fifty-fifth aspect, in combination with the fifty-fourth aspect, the techniques further include, during the double-sided RTT positioning operation, receiving, from the second UE, a second message of the one or more SL messages, the second message transmitted by the second UE using the second Tx power.

In a fifty-sixth aspect, in combination with the fifty-fifth aspect, the techniques further include determining the first pathloss value based on the second Tx power, the second message, or a combination thereof.

In a fifty-seventh aspect, in combination with the fifty-sixth aspect, identifying the first TX power includes determining the first Tx power based on the first pathloss value.

In one or more aspects, techniques for supporting power control for positioning may include additional aspects, such as any single aspect or any combination of aspects described below or in connection with one or more other processes or devices described elsewhere herein. In a fifty-eighth aspect, techniques for power control for positioning may include transmitting, to one or more UEs, a first SRS configuration associated with SL communication between multiple UEs including the UE and the one or more UEs. The first SRS configuration may indicate a first Tx power for SL communication and a first number of symbols per SL positioning instance associated with an SL positioning session. The techniques further include transmitting, to the one or more UEs, or receiving, from the one or more UEs, a first SL SRS position signal based on the first SRS configuration. In some examples, the techniques in the fifty-eighth aspect may be implemented in a method or process. In some other examples, the techniques of the fifty-eighth aspect may be implemented in a wireless communication device such as a UE, which may include a UE or a component of a UE. In some examples, the wireless communication device may include at least one processing unit or system (which may include an application processor, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include an interface (e.g., a wireless communication interface) that includes a transmitter, a receiver, or a combination thereof. Additionally, or alternatively, the wireless communication device may include one or more means configured to perform operations described herein.

In a fifty-ninth aspect, in combination with the fifty-eighth aspect the techniques further include, during a connection set up or discovery phase associated with the SL communication between the UE and the one or more UEs, determining one or more candidate Tx power configurations for SL communication and one or more candidate number of symbols per SL positioning instance.

In a sixtieth aspect, in combination with the fifty-ninth aspect, the one or more candidate Tx power configurations and the one or more candidate number of symbols per SL positioning instance acceptable to the UE and the one or more UEs.

In a sixty-first aspect, in combination with one or more of the first aspect through the sixtieth aspect, the techniques further include, during a connection set up or discovery phase associated with the SL communication between the UE and the one or more UEs, selecting the first SRS configuration based on the one or more candidate Tx power configurations and the one or more candidate number of symbols per SL positioning instance.

In a sixty-second aspect, in combination with the sixty-first aspect, to transmit the first SRS configuration, the techniques further include transmitting an RRC that indicates the first SRS configuration.

In a sixty-third aspect, in combination with the sixty-second aspect, the RRC is unicast or groupcast. In some implementations, the first SRS configuration may be unicast or groupcast.

In a sixty-fourth aspect, in combination with one or more of the fifty-eighth aspect through the sixty-third aspect, the techniques further include transmitting, to the one or more UEs, or receiving, from the one or more UEs, a second SRS configuration associated with the SL communication.

In a sixty-fifth aspect, in combination with the sixty-fourth aspect, the second SRS configuration indicating a second Tx power different from the first Tx power.

In a sixty-sixth aspect, in combination with the sixty-fourth aspect or the sixty-fifth aspect, the second SRS configuration indicating a second number of symbols per SL positioning instance associated with the SL positioning session.

In a sixty-seventh aspect, in combination with the sixty-sixth aspect, the second number of symbols different from the first number of symbols.

In a sixty-eighth aspect, in combination with one or more of the sixty-fifth aspect through the sixty-seventh aspect, the techniques further include transmitting, to the one or more UEs, or receiving, from the one or more UEs, a second SL SRS position signal based on the second SRS configuration.

In a sixty-ninth aspect, in combination with the sixty-eighth aspect, to transmit, to the one or more UEs, or receive, from the one or more UEs, the second SRS configuration the techniques further include transmitting or receiving an MAC-CE that indicates the second SRS configuration.

In a seventieth aspect, in combination with the sixty-ninth aspect, the MAC-CE is unicast or groupcast.

In a seventy-first aspect, in combination with one or more of the sixty-fourth aspect through the sixty-eighth aspect, the second SRS configuration is unicast or groupcast.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-10 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication performed by a network entity, the method comprising:
receiving, from a first user equipment (UE) of multiple UEs associated with a sidelink (SL) positioning session, first pathloss information based on SL communication associated with the multiple UEs; and
transmitting, to the first UE, first transmit power information that indicates a first transmit (Tx) power for Uu communication and the SL communication by the first UE, the first Tx power based on the first pathloss information.

2. The method of claim 1, wherein:
the SL communication includes an SL positioning session; and
the first Tx power information is transmitted to each UE of the multiple UEs.

3. The method of claim 1, wherein the first pathloss information indicates, for each other UE of the multiple UEs other than the first UE, an SL pathloss value associated with SL communication between the first UE and the other UE.

4. The method of claim 1, wherein the first pathloss information is associated with an SL positioning session and indicates a first reference signal received power (RSRP) of an SL sounding reference signal (SRS) position signal received by the first UE, a first SL SRS position measurement of the UE and associated with the SL SRS position signal, or a combination thereof.

5. The method of claim 4, wherein the SL SRS position signal is transmitted based on a default transmit power.

6. The method of claim 4, further comprising:
receiving, from a second UE of the multiple UEs, second pathloss information based on the SL communication associated with the multiple UEs, the second pathloss information is associated with the SL positioning session and indicates a second RSRP of the SL SRS position signal received by the second UE, a second SL SRS position measurement of the second UE and associated with the SL SRS position signal, or a combination thereof; and
determining the first Tx power based on the first pathloss information, the second pathloss information, or a combination thereof.

7. The method of claim 1, further comprising:
estimating, based on the first pathloss information, a UE-UE pathloss value, a UE-transmission and reception point (TRP) pathloss value, or a combination thereof; and
determining the first Tx power based on the UE-UE pathloss value, the UE-TRP pathloss value, or a combination thereof.

8. The method of claim 1, further comprising:
receiving a communication from the first UE;
determining a Uu pathloss value based on the communication; and
determining the first Tx power based on the first pathloss information and the Uu pathloss value.

9. The method of claim 1, wherein:
the first transmit power information indicates the first Tx power for multiple SL positioning instances of an SL positioning session associated with the multiple UEs.

10. The method of claim 1, further comprising:
receiving, for at least one SL positioning instance of multiple SL positioning instances of an SL positioning session associated with the multiple UEs, pathloss information associated with the at least one SL positioning instance.

11. The method of claim 1, further comprising:
receiving, from the first UE, second SL pathloss information associated with the first UE and a second UE and based on the first Tx power; and
transmitting, to the first UE, second transmit power information that indicates a second Tx power for the Uu communication and the SL communication, the second Tx power based on the second pathloss information.

12. The method of claim 11, wherein:
the second transmit power information indicates a change in Tx power from the first Tx power to the second Tx power.

13. The method of claim 11, wherein the second transmit power information indicates the second Tx power, to increase or decrease TX power, a Tx power change amount, or a combination thereof.

14. The method of claim 11, further comprising:
transmitting, to the first UE, a radio resource control (RRC), a medium access control-control element (MAC-CE), or downlink control information (DCI) that includes the second transmit power information.

15. A method of wireless communication performed by a first user equipment (UE), the method comprising:
receiving a pathloss scheme indicator from a network entity, the pathloss scheme indicator indicates a scheme of multiple pathloss schemes; and
determining, based on the scheme indicated by the pathloss scheme indicator, a first transmit (Tx) power for a sidelink (SL) positioning session by the first UE.

16. The method of claim 15, wherein the one scheme indicated by the indicator includes an SL pathloss scheme, and further comprising:
performing an SL discovery phase with one or more UEs; and
during the SL discovery phase, for each UE of the one or more UEs:
receiving a first message from the UE, the first message transmitted by the UE using a second Tx power;
determining a receive power associated with the first message from the UE; and
determining a pathloss value based on the first message from the UE; and
determining the first Tx power based on at least one pathloss value of the one or more UEs.

17. The method of claim 15, wherein the one scheme indicated by the indicator includes an uplink (UL) pathloss scheme, and further comprising:
determining, for each of one or more transmission and reception points (TRPs), a pathloss value based on Uu communication between the first UE and the TRP; and
determining the first Tx power based on the pathloss value of the one or more TRPs and independent of SL communication the first UE.

18. The method of claim 15, wherein the one scheme indicated by the indicator includes a joint SL and UL pathloss scheme, and further comprising:
determining first pathloss information based on Uu communication between the first UE and a set of one or more TRPs;
determining second pathloss information based on SL communication between the first UE and a set of one or more UEs; and
determining the first Tx power based on the first pathloss information and the second pathloss information.

19. The method of claim 18, wherein:
the set of one or more TRPs is selected from a set of one or more available TRPs by the first UE or selected by the network entity and indicated to the UE; and
the set of one or more UEs is selected from a set of one or more available UEs by the first UE or selected by the network entity and indicated to the UE.

20. A method of wireless communication performed by a first user equipment (UE), the method comprising:
identifying a first transmit (Tx) power based on one or more sidelink (SL) messages between the first UE and one or more UEs, the first Tx power based on a first pathloss value between the first UE and a second UE of the one or more UEs; and
transmitting an SL sounding reference signal (SRS) position signal based on the first Tx power.

21. The method of claim 20, further comprising:
performing an SL discovery phase with the one or more UEs; and
during the SL discovery phase, for each UE of the one or more UEs:
receiving a first message from the UE, the first message transmitted by the UE using a second Tx power;
determining a receive power associated with the first message from the UE; and
determining a pathloss value based on the first message from the UE; and
wherein identifying the first TX power includes determining the first Tx power based on at least one pathloss value associated with the one or more UEs.

22. The method of claim 21, wherein the first pathloss is determined as a maximum, a minimum, or an average based on the at least one pathloss value associated with the one or more UEs.

23. The method of claim 20, wherein the one or more SL messages are associated with a round trip time (RTT) positioning operation, and further comprising:
performing the RTT positioning operation with the second UE; and
during the RTT positioning operation:
transmitting a first message of the one or more SL messages, the first message transmitted based on a second Tx power to the second UE; and
receiving, from the second UE, a second message of the one or more SL messages, the message transmitted by the second UE using a third Tx power based on the first pathloss value associated with the first message; and
wherein the first TX power is identified based on the second message.

24. The method of claim 23, wherein the second messages indicates the first pathloss value, the third Tx power, or a combination thereof.

25. The method of claim 20, wherein the one or more SL messages are associated with a double-sided round trip time (RTT) positioning operation, and further comprising:
performing the double-sided RTT positioning operation with the second UE; and
during the double-sided RTT positioning operation:
transmitting a first message of the one or more SL messages, the first message transmitted based on a second Tx power to the second UE; and
receiving, from the second UE, a second message of the one or more SL messages, the second message transmitted by the second UE using the second Tx power.

26. The method of claim 25, further comprising:
determining the first pathloss value based on the second Tx power, the second message, or a combination thereof; and
wherein identifying the first TX power includes determining the first Tx power based on the first pathloss value.

27. A method of wireless communication performed by a user equipment (UE), the method comprising:
transmitting, to one or more UEs, a first sounding reference signal (SRS) configuration associated with sidelink (SL) communication between multiple UEs including the UE and the one or more UEs, the first SRS configuration indicating a first Tx power for SL communication and a first number of symbols per SL positioning instance associated with an SL positioning session; and
transmitting, to the one or more UEs, or receiving, from the one or more UEs, a first SL SRS position signal based on the first SRS configuration.

28. The method of claim 27, further comprising, during a connection set up or discovery phase associated with the SL communication between the UE and the one or more UEs:
determining one or more candidate Tx power configurations for SL communication and one or more candidate number of symbols per SL positioning instance, the one or more candidate Tx power configurations and the one or more candidate number of symbols per SL positioning instance acceptable to the UE and the one or more UEs; and
selecting the first SRS configuration based on the one or more candidate Tx power configurations and the one or more candidate number of symbols per SL positioning instance; and
wherein transmitting the first SRS configuration includes transmitting a radio resource control (RRC) that indicates the first SRS configuration, and wherein the RRC is unicast or groupcast.

29. The method of claim 27, further comprising:
transmitting, to the one or more UEs, or receiving, from the one or more UEs, a second SRS configuration associated with the SL communication, the second SRS configuration indicating:
a second Tx power different from the first Tx power, and
a second number of symbols per SL positioning instance associated with the SL positioning session, the second number of symbols different from the first number of symbols; and
transmitting, to the one or more UEs, or receiving, from the one or more UEs, a second SL SRS position signal based on the second SRS configuration.

30. The method of claim 29, wherein:
transmitting, to the one or more UEs, or receiving, from the one or more UEs, the second SRS configuration includes transmitting or receiving a medium access control-control element (MAC-CE) that indicates the second SRS configuration; and
the MAC-CE is unicast or groupcast.
